(19) United States
(12) Patent Application Publication
(10) Pub. No.: US 2017/0343425 A1
(43) Pub. Date: Nov. 30, 2017

(54) INDICATOR FOR THE QUALITY OF A PRODUCT

(71) Applicants: Ayoub ALZUMAYA, Madinah (SA); Yassine MANAI, Madinah (SA); Omar KAAKI, Madinah (SA); Adnan ALAHMADI, Madinah (SA); Saif ALHAISOUNI, Madinah (SA)

(72) Inventors: Ayoub ALZUMAYA, Madinah (SA); Yassine MANAI, Madinah (SA); Omar KAAKI, Madinah (SA); Adnan ALAHMADI, Madinah (SA); Saif ALHAISOUNI, Madinah (SA)

(21) Appl. No.: 15/537,858

(22) PCT Filed: Jan. 14, 2015
(86) PCT No.: PCT/IB2015/050273

§ 371 Date: Jun. 19, 2017

(51) Int. Cl. G01K 13/00; G01N 27/04; G01N 21/25

(52) U.S. Cl. CPC G01K 13/00; G01N 21/25; G01N 27/048

(57) ABSTRACT

Poster quality of codified standards for medical, food or industrial product which consist of chemical material that Influenced by surrounding factors such as temperature, humidity and expiration, where the ratio of the chemical material of the poster is adjusted depending on the product type and the extent of its vulnerability to these factors. The change of poster color indicates of exceed standards.

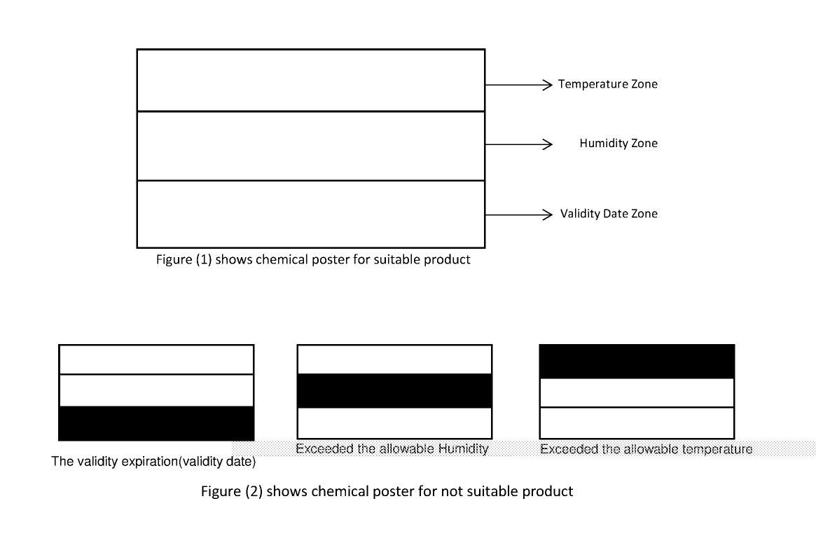

### BACKGROUND

Chemical invention, where is the current situation indicates that some of the products facing poor storage or a non-good transportation without knowing these problems either for the product owner or for the consumers, which may lead to health problems or environmental.

### GLOBAL DESCRIPTION

Poster quality of codified standards for medical, food or industrial product which consist of chemical material that Influenced by surrounding factors such as temperature, humidity and expiration, where the ratio of the chemical material of the poster is adjusted depending on the product type and the extent of its vulnerability to these factors. The change of poster color indicates of exceed standards.

1- Chemical poster featuring By automatic monitoring of the quality of materials that affected by heat, humidity or expiration.

2- Changing of poster color based on the interaction of chemical material inside the poster when it is influenced by temperature, humidity and expiration.

3- Adjust the ratio of the permittivity of the product which has been exposed to heat and humidity just based on consumed of material Characteristics.
